(19) United States
(12) Patent Application Publication
(10) Pub. No.: US 2018/0086435 A1
(43) Pub. Date: Mar. 29, 2018

(54) POWER SUPPLY APPARATUS FOR AEROSPACE ACTUATOR

(71) Applicant: Goodrich Control Systems, West Midlands (GB)

(72) Inventors: Thomas GIETZOLD, Warwickshire (GB); Joshua PARKIN, Solihull (GB)

(21) Appl. No.: 15/711,151

(22) Filed: Sep. 21, 2017

(30) Foreign Application Priority Data
Sep. 23, 2016 (EP) 16190465.1

(51) Int. Cl. B64C 13/50; H02P 23/07; B60L 7/14; H02J 7/34

(52) U.S. Cl. CPC B64C 13/50; H02P 23/07; B64D 2221/00; H02J 7/34; B60L 7/14

(57) ABSTRACT

A power supply apparatus for an aerospace actuator includes motor drive electronics for actuation of a motor for control of the aerospace actuator, and an energy storage device. The motor drive electronics are configured to receive input electrical energy from an aircraft power grid, receive electrical energy from the energy storage device and provide electrical energy from the grid and/or from the energy storage device to the motor. The energy storage device is configured to store at least one of: excess electrical energy supplied to the motor drive electronics from the grid and regenerated electrical energy from the motor drive electronics. The energy storage device is configured to discharge the stored energy as electrical energy to the motor drive electronics when required.

### FOREIGN PRIORITY

This application claims priority to European Patent Application No. 16190465.1 filed Sep. 23, 2016, the entire contents of which is incorporated herein by reference.

### TECHNICAL FIELD

The present invention relates to a power supply apparatus for an aerospace actuator. In particular, the field of the disclosure lies in the area of motor drive electronics in aircraft.

### BACKGROUND

Nowadays, it is becoming increasingly common to design aircraft with at least some electric actuation instead of the previously ubiquitous hydraulic actuation. In order to supply the electricity to the actuators in far-reaching areas of the aircraft (such as the wings, for example), wires or cables must extend to those areas.

Many of the actuators on an aircraft operate in a pulsed manner. For example, aircraft ailerons or flaps on the wings are usually not moved constantly but rather intermittently, as and when they need to be altered for good control of the aircraft. Thus the power supplied to these actuators occurs in short intervals of relatively higher power, compared to the relatively much lower power supplied continuously from the aircraft.

The wires, cables and other current-carrying components at the input-side of the actuator electronics must be large enough and sized to withstand the high powers which are required by from this intermittent electricity demand. This involves having wires of significant gauge, large circuit breakers and other large equipment.

### SUMMARY

Viewed from a first aspect, the present invention provides a power supply apparatus for an aerospace actuator, comprising: motor drive electronics for actuation of a motor for control of the aerospace actuator; and an energy storage device; wherein the motor drive electronics are configured to: receive input electrical energy from an aircraft power grid; receive electrical energy from the energy storage device; and provide electrical energy from the grid and/or from the energy storage device to the motor; wherein the energy storage device is configured to store at least one of excess electrical energy supplied to the motor drive electronics from the grid and regenerated electrical energy from the motor drive electronics, and wherein the energy storage device is configured to discharge stored energy as electrical energy to the motor drive electronics when required.

The excess electrical energy may be energy supplied to the motor drive electronics from the grid in excess of the requirements of the motor. By storing at least one of electrical energy and regenerated electrical energy in an energy storage device and subsequently releasing the stored energy to the motor drive electronics when required for actuation of the actuator, then higher peak powers can be delivered than could be directly supplied to the motor drive electronics from the grid alone. The motor drive electronics may receive input electrical energy from the aircraft power grid at the same time as receiving electrical energy from the energy storage device, or at any given time the motor drive electronics may receive input electrical energy only from the aircraft power grid or only from the energy storage device. An energy storage device as discussed herein could be provided for the motor drive electronics for each of multiple actuators on an aircraft. Thus, a power supply apparatus may comprise multiple sets of energy storage devices and motor drive electronics in order to power multiple actuators.

In addition, the inventors have realised that one of the problems with equipment used for electrical power transmission in aircraft is the weight involved, in particular because the wires and other equipment must pass along a significant distance from the generator to the extremities of the aircraft, such as to the wing actuators. Given an approximate ratio of 10 between average and peak current, a weight savings for a particular actuator can be calculated in the following way.

An actuator might require 5 kW at peak power at 540 Vdc translating to a 9A current at its input terminals. This current demand will require at least an AWG12 (2.05 mm diameter) cable installation. Applying the invention can reduce the average power draw to 500 W therefore allowing an AWG22 (0.65 mm diameter) type of cable to be used. Assuming the wingspan of a single isle twin engine transport category aircraft of 120 ft (36.6 m), and the length of a 100 ft (30.5 m), an average actuators distance to the power source might be well over 50 ft (15.2 m) requiring about 2 lb (0.91 kg) of power cable. This weight multiplied by the number of approx. 20 actuators can easy reach 40 lb (18.1 kg) or more, which can be reduced to 4 lb (1.8 kg).

Therefore, significant weight savings in an aircraft could be provided depending on the size of an aircraft, the rating of the actuator and the number of actuators. Accordingly, the wires and other components conventionally carrying power to the motor drive electronics via the grid can be reduced in size since the required current in the wires and other components would be significantly reduced. Thus the present invention provides a weight saving system compared to known systems. A lighter aircraft will require less fuel to power and thus causes less environmental damage than a heavier aircraft.

Additionally, the complexity of the input power circuit could be reduced by the reduction of the size of circuit breakers and other power-trip safety devices, thus there is increased simplicity and further weight savings. Moreover, the provision of an energy storage device having stored energy allows a source of temporary back-up power should the power supply from the grid fail. Since there can be a local energy storage device for each of multiple actuators having their own local motor drive electronics then power can still be supplied to these actuators at a local level if a generator of the aircraft fails or if there is a local or system-wide failure of the grid.

The energy storage device may comprise a battery and/or a supercapacitor.

The battery may be a lithium ion battery. Lithium ion batteries are rechargeable high-performance batteries which have a high energy density (energy per unit mass) compared to many other forms of energy storage device. Lithium ion batteries may have an energy density of the order of 120-140 Wh/kg but are limited by the number of cycles which they can withstand (order of about 500). The specific power produced is of the order of 1000-3000 W/kg. Further, the charge time of a lithium ion battery is of the order of about 1 hour.

A supercapacitor is also known as an ultracapacitor, or a double-layer capacitor. Supercapacitors are conventionally used in applications of energy storage where the storage is to undergo frequent charge and discharge cycles at high current and short duration. Where a supercapacitor is present then the specific energy of the supercapacitor may be of the order of about 5 Wh/kg and/or the specific power may be of the order of about up to 10,000 W/kg. The supercapacitor can advantageously go through many cycles of charge and discharge, of the order of 1 million, without degradation of performance. Further, the charge time of the supercapacitor may be of the order of about 10 seconds.

The energy storage device may be configured to store energy which is supplied from the grid and is not needed by the motor drive electronics. This may be energy supplied when the actuator is not being adjusted (i.e. no energy is needed by the motor drive electronics) or it may be excess energy which is surplus to the requirements of the motor drive electronics for adjusting the actuator (i.e. not all of the supplied energy is needed by the motor drive electronics). The energy storage device may also be configured to alternatively or additionally store energy which is regenerated in the motor drive electronics. For example, if an aircraft flap needs to be moved in a direction which is the same direction as the aerodynamic load is pushing on the flap, e.g. to a more streamlined position, then the energy to move the actuator can be provided by the environmental forces and electrical energy can thus be regenerated in the motor drive electronics.

In at least some embodiments, the energy storage device comprises a bi-directional power converter for controlling the flow of electrical energy between the motor drive electronics and the energy storage device.

The bi-directional power converter may allow movement of electrical energy from the input energy supplied by the grid to the energy storage device for storage in the energy storage device. This occurs for example when the energy supplied by the grid to the motor drive electronics exceeds the requirements of the motor drive electronics, such as when there is no requirement for the grid to drive the motor, or when the motor requires a smaller electrical current than can be provided by the grid. It can also occur when the motor drive electronics is able to regenerate electrical energy from an actuator movement. In this case, the excess electrical energy can pass through the bi-directional power converter to be stored in the energy storage device, unless the energy storage device is already at full capacity, in which case the bi-directional power converter may prevent further excess energy passing to the energy storage device.

The bi-directional converter may also allow flow of power in the reverse direction, for example when it is desired to drive the motor without drawing energy from the grid and/or when the energy being supplied by the grid to the motor drive electronics is insufficient for the requirements of the motor drive electronics. In this case, previously stored energy from the energy storage device can be discharged from the energy storage device, through the bi-directional power converter, and delivered to the motor drive electronics as required. Thus the stored energy can pass through the bi-directional power converter in the reverse direction to the motor drive electronics, to supplement the supplied grid energy as required.

It will be appreciated that the energy storage device will generally provide and receive DC power. The motor drive electronics may be arranged to receive DC power from the grid and/or from the energy storage device.

The grid may be an AC power grid, which may be arranged in a 3-phase or single-phase power arrangement AC power may be supplied by a generator in the aircraft or from another suitable power source. Accordingly, to power any DC electronics of the power supply apparatus, an AC/DC converter may be present.

Viewed from a second aspect, the invention provides an aircraft comprising at least one actuator and a power supply apparatus as discussed above for supplying power to the actuator. There may be a plurality of energy storage devices for a plurality of the actuators of the aircraft. In this way there may be a local energy storage device for the motor drive electronics for each of the plurality of actuators. In this case the power supply apparatus may include other elements of the aircraft power supply system and/or may be connected thereto. The aircraft may also include a grid as discussed above, along with a generator for supplying power to the grid. The aircraft may include wiring for transmission of electrical energy to the at least one actuator. It will be appreciated that by the use of the invention then the aircraft can be made lighter and more efficient whilst still supplying the required electrical energy to the actuator(s) of the aircraft.

Viewed from a third aspect, the invention provides a method for supplying power to an aerospace actuator of an aircraft using a power supply apparatus comprising motor drive electronics and an energy storage device; the method comprising: receiving input electrical energy from a grid at the motor drive electronics; storing in the energy storage device at least one of: excess electrical energy supplied to the motor drive electronics from the grid; and regenerated electrical energy from the motor drive electronics; discharging electrical energy from the energy storage device to the motor drive electronics when required; and using the motor drive electronics to provide electrical energy from the grid and/or from the energy storage device to a motor for control of the aerospace actuator.

The method of this aspect may include using an apparatus as discussed above in relation to the first aspect and optional features thereof.

The method may comprise preventing discharged energy from the energy storage device from leaking into the grid.

The energy supplied by the energy storage device to the actuator may be in addition to and/or in excess of energy already supplied by a grid. Thus the method may include using the energy storage device to provide higher peak power levels to the aircraft actuator than the power levels that are possible without the energy storage device.

Since energy is also provided by a local energy storage device, less energy may be required from the grid and consequently the size of the wires coming from the grid may be reduced. The method may hence include reducing the size of power transmission wires and/or other power transmission devices of the aircraft compared to aircraft without the energy storage device, for example by reducing the size of power transmission wires and/or other power transmission devices whilst not reducing the capabilities of the power supply apparatus to meet the requirements of the aircraft actuator(s). As discussed above, significant weight savings can be realised as the power transmission wires may span a great length, for example from the aircraft generator to actuators on the extremities of the wings and/or tail of the aircraft.

The method may include supplying energy from the energy storage device to the actuator in the case of a power failure on the aircraft. The energy storage device may hence be used to provide a local source of temporary backup power should the generator or grid fail for some reason.

In any of the above aspects, the continuous power supplied to the motor drive electronics may be of the order of 50-500 W, while the peak power supplied to the motor electronics by discharge from the energy storage may be of the order of 5-7 kW.

### BRIEF DESCRIPTION OF THE DRAWINGS

Preferred embodiments of the present disclosure will now be described by way of example only and with reference to the accompanying drawing, in which:

FIG. 1 shows a power supply apparatus for an actuator, the power supply apparatus including an energy storage device.

### DETAILED DESCRIPTION

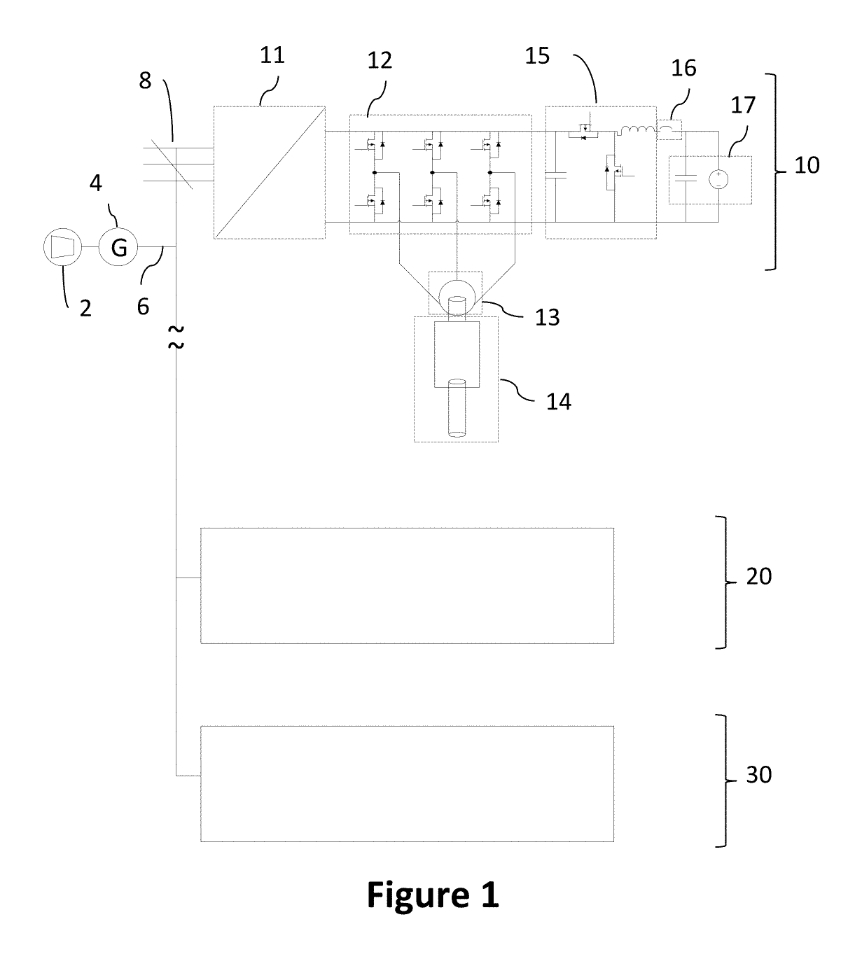

As shown in FIG. 1, an aircraft comprises a prime mover 2, in the form of an engine. The prime mover 2 causes a generator 4 to generate power, which is supplied to a grid 6. The power is distributed to multiple actuator power supplies 10, 20, 30 in the grid 6 via single phase or 3-phase power distribution lines 8. The distributed power is usually 3-phase AC power at 115V, or single-phase AC power at 230V AC. In the latter case, the power distribution lines 8 are a voltage bus.

In each actuator power supply 10, 20, 30, there is an AC/DC converter 11 to convert the input power into DC power. This DC power can be passed via motor drive electronics 12 to an electric motor 13 of an actuator 14. Connected to the motor drive electronics 12 is a bi-directional power converter 15. This controls the flow of power between the motor drive electronics 12 and an energy storage device 17, which takes the form of a battery in this example. The bi-directional power converter 15 also allows for power to pass from the grid 6 to the energy storage device 17 as well as permitting power to flow in the opposite direction from the energy storage device 17 to the motor drive electronics 12. A circuit breaker 16 is provided to ensure that the motor drive electronics 12 are not overloaded by a power surge from the energy storage device 17 as it discharges.

The bi-directional power converter 15 allows movement of electrical energy from the input energy supplied by the grid 6 to the energy storage device 17 for storage in the energy storage device 17. This occurs for example when the energy supplied by the grid 6 to the motor drive electronics exceeds the requirements of the motor drive electronics 12, such as when there is no requirement to drive the motor 13, or when the motor 13 requires a smaller electrical current than can be provided from the grid 6. In this case, the excess electrical energy can pass through the bi-directional power converter 15 to be stored in the energy storage device 17. If the energy storage device 17 is already at full capacity then the bi-directional power converter 15 may prevent further excess energy passing to the energy storage device 17.

The bi-directional converter 15 allows flow of power in the reverse direction, when it is desired to drive the motor 13 without drawing energy from the grid 6 and/or when the energy being supplied by the grid 6 to the motor drive electronics 12 is insufficient for the requirements of the motor 12 and should be supplement by energy from the energy storage device 17. In this case, previously stored energy from the energy storage device 12 is discharged through the bi-directional power converter 15 and delivered to the motor drive electronics 12 for powering the motor 13 as required.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A power supply apparatus for an aerospace actuator, comprising:
motor drive electronics for actuation of a motor for control of the aerospace actuator; and
an energy storage device;
wherein the motor drive electronics are configured to:
receive input electrical energy from an aircraft power grid;
receive electrical energy from the energy storage device; and
provide electrical energy from the grid and/or from the energy storage device to the motor; and
wherein the energy storage device is configured to store at least one of:
excess electrical energy supplied to the motor drive electronics from the grid; and
regenerated electrical energy from the motor drive electronics; and
wherein the energy storage device is configured to discharge the stored energy as electrical energy to the motor drive electronics when required.

2. A power supply apparatus as claimed in claim 1, wherein the energy storage device comprises a battery.

3. A power supply apparatus as claimed in claim 2, wherein the battery comprises a lithium ion battery.

4. A power supply apparatus as claimed in claim 1, wherein the energy storage device comprises a supercapacitor.

5. A power supply apparatus as claimed in claim 1, comprising a bi-directional power converter for controlling the flow of power between the motor drive electronics and the energy storage device.

6. A power supply apparatus as claimed in claim 1, configured such that motor drive electronics can: (i) receive input electrical energy from the aircraft power grid at the same time as receiving electrical energy from the energy storage device, (ii) receive input electrical energy only from the aircraft power grid, or (iii) receive input electrical energy only from the energy storage device.

7. An aircraft comprising:
at least one actuator; and
a power supply apparatus as claimed in claim 1, for supplying power to the actuator.

8. An aircraft as claimed in claim 7, comprising multiple actuators with each actuator having associated motor drive electronics and an energy storage device being connected with each of the motor drive electronics.

9. A method for supplying power to an aerospace actuator of an aircraft using a power supply apparatus comprising motor drive electronics and an energy storage device; the method comprising:
receiving input electrical energy from a grid at the motor drive electronics;
storing in the energy storage device at least one of:
excess electrical energy supplied to the motor drive electronics from the grid; and
regenerated electrical energy from the motor drive electronics;
discharging electrical energy from the energy storage device to the motor drive electronics when required; and
using the motor drive electronics to provide electrical energy from the grid and/or from the energy storage device to a motor for control of the aerospace actuator.

10. A method as claimed in claim 9, further comprising:
using a power supply that includes:
motor drive electronics for actuation of a motor for control of the aerospace actuator; and
an energy storage device;
wherein the motor drive electronics are configured to:
receive input electrical energy from an aircraft power grid;
receive electrical energy from the energy storage device; and
provide electrical energy from the grid and/or from the energy storage device to the motor; and
wherein the energy storage device is configured to store at least one of:
excess electrical energy supplied to the motor drive electronics from the grid; and
regenerated electrical energy from the motor drive electronics; and
wherein the energy storage device is configured to discharge the stored energy as electrical energy to the motor drive electronics when required.

11. A method as claimed in claim 9, further comprising preventing discharged energy from the energy storage device from leaking into the grid.

12. A method as claimed in claim 9, wherein the energy supplied by the energy storage device to the motor for control of the aerospace actuator is in addition to or in excess of energy already supplied by the grid.

13. A method as claimed in claim 12, wherein the energy supplied by the energy storage device to the motor for control of the aerospace actuator is in addition to energy regenerated in the motor drive electronics.

14. A method as claimed in claim 12, comprising using the energy storage device to provide higher peak power levels to the aircraft actuator than the power levels that are possible without the energy storage device.
